(19) United States
(12) Patent Application Publication
(10) Pub. No.: US 2019/0134537 A1
(43) Pub. Date: May 9, 2019

(54) ENHANCED FLOCCULATION AND ENERGY DISSIPATION INLET FOR CIRCULAR WATER AND WASTEWATER CENTER-FEED CLARIFIERS

(71) Applicant: Clarifiers, Inc, Enfield, NH (US)

(72) Inventors: William Hartnett, Torrance, CA (US); John K. Esler, Enfield, NH (US)

(21) Appl. No.: 16/106,695

(22) Filed: Aug. 21, 2018

Related U.S. Application Data
(60) Provisional application No. 62/548,468, filed on Aug. 22, 2017.

(51) Int. Cl. B01D 21/24; B01D 21/01; B01D 21/00; C02F 1/52

(52) U.S. Cl. CPC B01D 21/2405; B01D 21/01; C02F 2001/007; C02F 1/5281; B01D 21/0087

(57) ABSTRACT

An enhanced flocculation influent feedwell assembly for water and wastewater treatment clarifiers is configured for being disposed about a riser of a clarifier and from which riser pipe a liquid enters the influent feedwell. The influent feedwell has a floor region having an opening and a sidewall region. A plurality of preferably arcuately shaped fins are disposed on the floor region in a circular pattern around the opening in the floor region and have a height which is generally equal to a height of the sidewall region. A plurality of preferably non-arcuately shaped fins are periodically disposed on the sidewall of the influent feedwell in a spaced apart manner and have a height which is less than the height of the sidewall region. The plurality of non-arcuately shaped fins are disposed such that they are spaced apart from and do not contact the floor region of the influent feedwell.

### CROSS-REFERENCE TO RELATED APPLICATIONS

This application claims priority from U.S. Provisional Patent Application No. 62/548,468, titled “ENHANCED FLOCCULATION AND ENERGY DISSIPATION INLET FOR CIRCULAR WATER AND WASTEWATER CENTER-FEED CLARIFIERS”, which was filed on Aug. 22, 2017 and is incorporated fully herein by reference.

### TECHNICAL FIELD

The present invention relates to water and wastewater treatment clarifiers and more particularly, relates to an enhanced flocculation and energy dissipation inlet for circular water and wastewater center-feed clarifiers that combines the processes of dissipating the energy of the jets from the inlet ports and enhancing the flocculation of the particles in the water or wastewater.

### BACKGROUND INFORMATION

A clarifier is a reactor whose purpose is to separate solids from water or wastewater. These solids must be able to settle and to form sediments. For a clarifier to function properly, particulates and the wastewater must be allowed to flocculate and form solids that can be removed from the water.

Flocculation refers to the separation of a solution and most commonly, this word is used to describe the removal of a sediment from a fluid. In addition to occurring naturally, it can also be forced through agitation or the addition of flocculating agents. Many manufacturing industries use it as part of their processing techniques, and it is also extensively employed in water/wastewater treatment.

Problems exist, however, in the process of flocculating and separating solids from the liquid. Effective separation of the solids may not occur due to poor flocculation and the formation of unwanted currents within the clarifier. To enhance flocculation, several different types of feed wells (also referred to as stilling wells, influent wells or center wells) have been developed over the years for use in clarifiers. One such prior art clarifier with an enhanced flocculation influent well is described in U.S. Pat. No. 6,276,537, the subject matter of which is incorporated herein by reference.

Although the feed well described in the above referenced US patent serves as an improvement over the prior art, it has been determined that an improved design of the central region of this prior art feed well could improve flocculation.

Accordingly, the present invention features a newly designed baffle system for the central feed well in an Energy Dissipating Inlet (EDI) design for water clarification/treatment systems.

### SUMMARY OF THE INVENTION

The present invention features an enhanced flocculation feedwell assembly for water and wastewater treatment clarifiers. The assembly comprises an influent feedwell, configured for being disposed about an influent riser pipe or side feed pipe of a clarifier and from which influent riser or side feed pipe a liquid enters the influent feedwell. The influent feedwell has a floor region and a sidewall region. At least one of the floor region or sidewall region has an opening through which the influent riser pipe or side feed pipe is disposed

The enhanced flocculation feedwell assembly also features a plurality of fins periodically disposed on the floor region of the influent feedwell and disposed in a circular pattern around an opening in the floor region of the feed well through which the riser pipe is disposed. The plurality of fins have a height which generally corresponds to a height of the sidewall region of the influent feedwell.

A plurality of fins are periodically disposed on the sidewall of the influent feedwell in a spaced apart manner. The plurality of fins have a height which is less than the height of the sidewall region of the influent feedwell. The plurality of fins are disposed such that they are spaced apart from and do not contact the floor region of the influent feedwell.

The enhanced flocculation feedwell assembly includes, in one embodiment, wherein the plurality of fins periodically disposed on the floor region of the influent feedwell are arcuately shaped fins, and wherein the plurality of fins periodically disposed on the sidewall of the influent feedwell are non-arcuately shaped fins.

The enhanced flocculation feedwell assembly includes, in a further embodiment, wherein the plurality of arcuately shaped fins are disposed on the floor region of the influent feedwell in a predetermined spaced-apart manner creating a region of predetermined length between a first end of each of two adjacent arcuately shaped fins.

In the further embodiment of the enhanced flocculation feedwell assembly, each of the plurality of non-arcuately shaped fins are disposed on the sidewall region of the influent feed well at a location at equally spaced intervals around the interior circumference of the wet well wall.

In the further embodiment of the enhanced flocculation feedwell assembly, the plurality of non-arcuately shaped fins are disposed at 45, 60, and/or 90 degree intervals around the interior circumference of the wet well wall as determined by a factor of the diameter of the wet well as determined by the range of influent flows.

### BRIEF DESCRIPTION OF THE DRAWINGS

The patent or application file contains at least one drawing executed in color. Copies of this patent or patent application publication with color drawing(s) will be provided by the Office upon on request and payment of the necessary fee.

These and other features and advantages of the present invention will be better understood by reading the following detailed description, taken together with the drawings wherein:

FIG. 1 is a perspective view of an enhanced flocculation and energy dissipation feedwell assembly in accordance with the teachings of the present invention;

FIG. 2 shows the influent velocity distribution in a horizontal plane of the prior art without arcuately shaped fins and the straight sidewall fins in accordance with the teachings of the present invention;

FIG. 3 shows the influent velocity distribution in the horizontal plane utilizing both arcuately shaped fins and the straight sidewall fins in accordance with the teachings of the present invention; and

FIG. 4 shows a top view of the feed well assembly according to the present invention including arcuately shaped fins and straight sidewall fins in connection with a central opening and outlet openings.

### DETAILED DESCRIPTION OF THE PREFERRED EMBODIMENTS

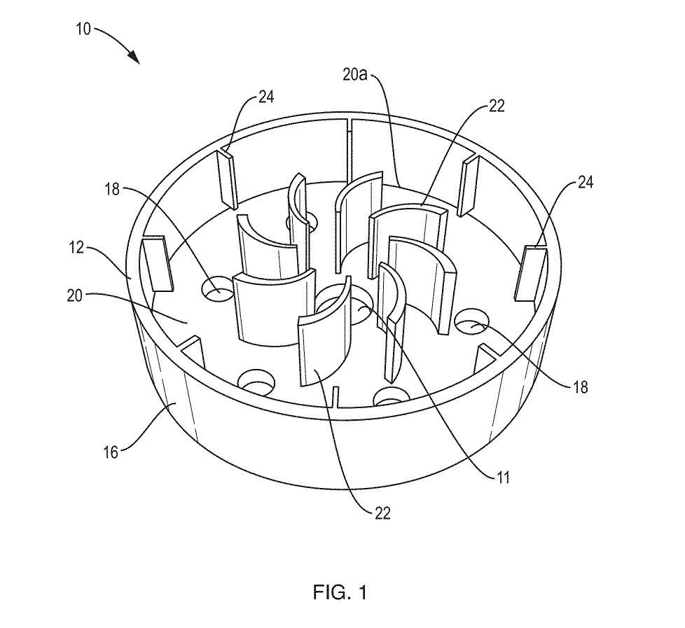

Referring to the drawings and particularly to FIG. 1, there is illustrated an enhanced flocculation and energy dissipation feedwell assembly, generally designated 10, of the present invention which is mounted to an influent riser pipe P (not shown but known in the art) inserted in opening 11 of a clarifer. The enhanced feedwell assembly 10 includes an influent feedwell 12 and a plurality of feed outlet structures (not shown) supported by the influent feedwell 12. The feed outlet structures are preferably disposed below the influent feedwell 12, though in some applications may be disposed at any other suitable locations. Liquid, such as water or wastewater, enters the influent feedwell 12 from the influent riser pipe P through opening 11.

The influent feedwell 12 includes a bottom floor portion 20 and a continuous sidewall 16. The bottom floor portion 20 has a substantially circular configuration of any suitable diameter and a periphery 20a. The sidewall 16 has a substantially cylindrical configuration of a diameter substantially similar to the diameter of the bottom floor 20. The sidewall 16 is connected to the bottom floor portion 20 at its periphery 20A and is disposed substantially upright from the bottom floor portion 20. Alternatively to a circular configuration, the bottom and side walls 20, 16 can have polygonal shapes.

The influent feedwell 12 has a size which is substantially a function of the size of the clarifer. The influent feedwell 12, generally, has a floor 20 which includes a plurality of holes 18 to which the at least one and preferably the plurality of feed outlet structures (not shown) are supported. The holes 18 are spaced outwardly from the opening 11 and spaced inwardly from the periphery 20a and spaced apart from one another.

In the illustrated example, the holes 18 are eight in number. The holes 18 are spaced radially outwardly from the opening 11 and along a circle concentric with the opening 11. The sidewall 16 of the influent feedwell 12 is spaced outwardly from the holes 18. Each of the holes 18 has a substantially circular or square configuration and a diameter or area substantially less than the diameter or area of the opening 11.

The bottom 20 of the influent feedwell 12 defines an opening 11. The opening 11 is defined at a center of the bottom wall 20. The influent feedwell 12 is disposed concentrically about the influent riser pipe P of the clarifier and the opening 11 receives the influent riser pipe P therethrough. The opening 11 has a substantially circular configuration, and is concentric about a vertical axis of the influent riser pipe P and influent feedwell 12. The opening 11 has a diameter which is substantially less than the diameters of the bottom portion 20 which has a diameter to provide the necessary clearance of 1 to 2 inches from the clarifier mechanism drive cage structure.

The influent feedwell 12 may be fixed to the influent riser pipe P in any suitable well-known manner or may rotate as part of a rotating system of the clarifier.

In the preferred embodiment, the feedwell assembly 10 includes a plurality of fins 22 generally evenly spaced around the central opening 11. The fins 22 are preferably arcuately shaped but this is not a limitation of the invention. The plurality of fins 22 a height proportional to the sidewall portion 16 and are attached to the bottom floor portion 20 of the influent feedwell 12. The number and arrangement of the fins 22 is dependent upon the influent pipe diameter (not part of the device), the number and size of the influent ports, and the diameter of the energy dissipating wetwell, which is, of course, dependent upon the design influent flow capacity. The object of the fin arrangement is to ensure that an appropriate proportion of the influent flow is caused to impact the fins 22 causing the first stage of flocculation to occur by the rotary motion of the redirected influent flow. The number and placement of the fins is designed to prevent bypassing of any part of the influent flow without redirection and with no consequence of the mounting method of the influent well, i.e. whether the well rotates with the support cage or is stationary, i.e. supported from the non-rotating structure of the clarifier equipment. The height of the fins must generally be the full height of the feedwell in order to capture and redirect the full influent flow as it exits the center feed pipe.

In addition to the arcuately shaped fins 22, the preferred embodiment of the present invention includes a plurality of straight fins 24 attached to the inside of the sidewall 16. The straight fins 24 have a height which is less than that of the sidewall 16 and are spaced away from the bottom floor portion 20 by approximately 6 inches. The straight fins 24 are located or positioned on the sidewall 16 at a location which is approximately 90, 60, or 45 degrees around the internal circumference of the wet well. The straight fins 24 protrude outwardly from the sidewall 16 by approximately 6 to 12 inches. The number of the straight fins 24 is independent of the number of fins 22 and is strictly dependent upon the circumference of the wet well which is dependent upon the range of the influent flows.

The primary objective of providing the combination of the arcuately shaped fins 22 and the straight sidewall fins 24 is to induce/optimize effluent velocities and particle contact within the feedwell assembly 10. Optimizing influent velocities and particle contact is accomplished by optimizing influent flow to steer the flow away from the sidewall 16 which creates a flow pattern that favors flocculation.

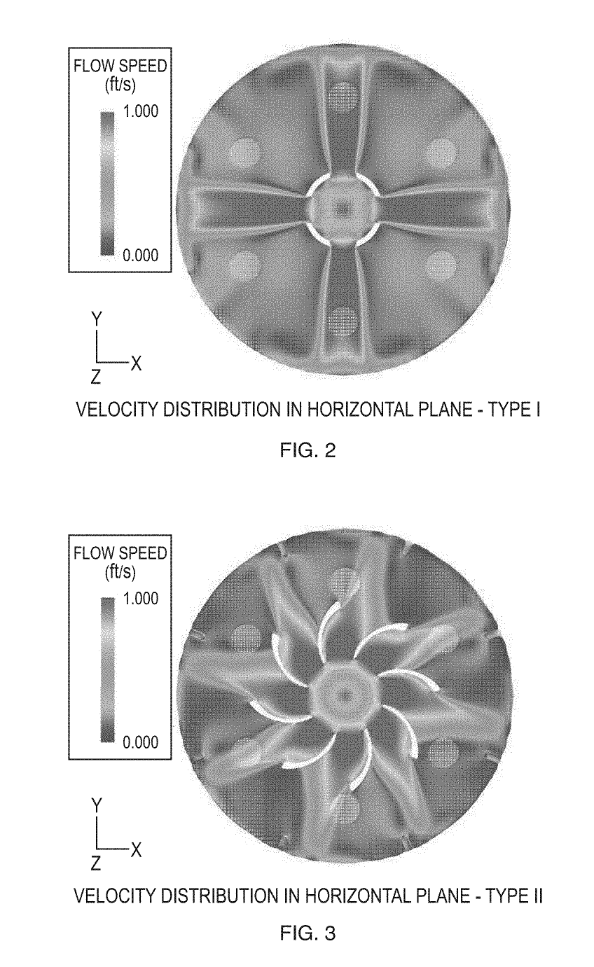

FIG. 2 shows the velocity distribution in a horizontal plane of the prior art without arcuately shaped fins 22 and the straight sidewall fins 24. The distribution shows relatively high flow speeds in predetermined directions corresponding to openings in the influent riser pipe P while also showing that the influent strikes the sidewall 16 thus creating a flow pattern that does not favor flocculation to the greatest extent possible.

FIG. 3, on the other hand, shows a velocity distribution in the horizontal plane utilizing both the arcuately shaped fins 22 and the straight sidewall fins 24. As can be seen, the velocity of the influent decreases significantly and rapidly as the influent moves away from the openings in the influent riser pipe P thus creating significantly more favorable conditions for flocculation which is desired particularly in a wastewater treatment system.

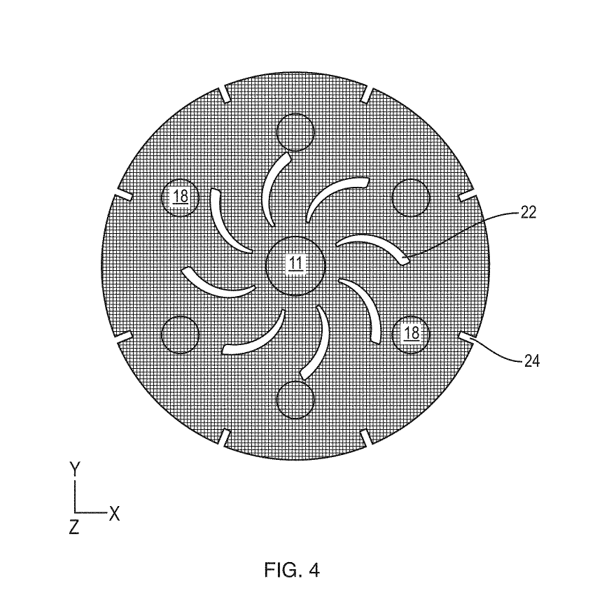

FIG. 4 shows a top view of the feed well assembly according to the present invention including arcuately shaped fins 22 and straight sidewall fins 24 in connection with the central opening 11 and the outlet openings 18.

It is understood that the present invention will be designed to be installed in clarifiers with diameters from typically 25 feet up to 250 feet, with the diameter of the (wet) influent feedwell well varying anywhere from 10% to 50% of the clarifier diameter. Flows through the clarifiers can vary anywhere from 300 gal/day/sq. ft. of surface area up to typically 2000 gal/day/sq. ft., so one skilled in the art can see the need for maximum flexibility in design parameters.

Modifications and substitutions by one of ordinary skill in the art are considered to be within the scope of the present invention, which is not to be limited except by the allowed claims and their legal equivalents.

The invention claimed is:

1. An enhanced flocculation feedwell assembly for water and wastewater treatment clarifiers, said assembly comprising:
an influent feedwell configured for being disposed about an influent riser pipe or side feed pipe of a clarifier and from which influent riser or side feed pipe a liquid enters said influent feedwell, said influent feedwell having a floor region and a sidewall region, at least one of said floor region or sidewall region having an opening through which said influent riser pipe or side feed pipe is disposed;
a plurality of fins periodically disposed on said floor region of said influent feedwell and disposed in a circular pattern around an opening in said floor region of said feed well through which said riser pipe is disposed, said plurality of fins having a height which is proportional to the height of said sidewall region of said influent feedwell; and
a plurality of fins periodically disposed on said sidewall of said influent feedwell in a spaced apart manner, said plurality of fins having a height which is less than said height of said sidewall region of said influent feedwell, said plurality of fins disposed such that they are spaced apart from and do not contact said floor region of said influent feedwell.

2. The assembly of claim 1, wherein said plurality of fins periodically disposed on said floor region of said influent feedwell are arcuately shaped fins, and wherein said a plurality of fins periodically disposed on said sidewall of said influent feedwell are non-arcuately shaped fins.

3. The assembly of claim 2, wherein said plurality of arcuately shaped fins are disposed on said floor region of said influent feedwell in a predetermined spaced-apart manner creating a region of predetermined length between a first end of each of two adjacent arcuately shaped fins.

4. The assembly of claim 3, wherein each of said plurality of non-arcuately shaped fins are disposed on said sidewall region of said influent feed well at a location at equally spaced intervals around the interior circumference of the wet well wall.

5. The assembly of claim 4, wherein the plurality of non-arcuately shaped fins are disposed at 45, 60, and/or 90 degree intervals around the interior circumference of the wet well wall as determined by a factor of the diameter of the wet well as determined by the range of influent flows.
